(19) United States
(12) Patent Application Publication
(10) Pub. No.: US 2010/0010119 A1
(43) Pub. Date: Jan. 14, 2010

(54) Corrosion-Resistant Epoxy Nanocomposite Coatings containing Submicron Emeraldine-Base Polyaniline and Organomodified Montmorrilonite

(76) Inventors: Davood Zaarei, Tehran (IR); Ali Asghar Sarabi, Tehran (IR); Farhad Sharif, Tehran (IR); Mohsen Moazzami Gudarzi, Tehran (IR); Seyed Mahmoud Kassiriha, Tehran (IR)

Correspondence Address: BARRY CHOOBIN, TALEGHANI, BAHARE SHOMALI , #219, SUITE#18, TEHRAN, 1563714311, IR

(21) Appl. No.: 12/563,116

(22) Filed: Sep. 19, 2009

(51) Int. Cl. C09D 163/00

(52) U.S. Cl. 523/461; 524/186

(57) ABSTRACT

Disclosed is a method of preparation of corrosion-resistant epoxy coatings. The coating composition contains two main corrosion resistant factors: The first one was Eemeraldine-Base polyaniline (EB-PANi), dissolved in the aminic hardener of epoxy. The other one was montmorrilonite clay, dispersed or exfoliated in the base component of epoxy resin. The hardener composition was prepared via dissolution of EB-PANi in functional amines like 3-(aminomethyl)-3,5,5-trimethylcyclohexan-1-amine adopting sonication and nanoscale filtering methods. The base component was prepared via gradual charging of MMT clay in epoxy resin via high-shear mixing plus sonication method. The morphology of the coatings during different stages of preparation was studied by optical microscopy and scanning electron microscopy and TEM. The corrosion-protective performance of the resultant coatings was evaluated by electrochemical impedance spectroscopy and salt spray tests. The results were compared with those of conventional epoxy zinc-chromate and neat resin coatings. Superior corrosion resistance was achieved via dissolution of 0.5-2.5 wt % of EB-PANi in the aminic hardener and 2-4 WT % of organomodified MMT in base component of coating.

### FIELD OF THE INVENTION

The present invention relates to organic anticorrosive coatings for metals. More particularly, it relates to coatings comprising polyaniline in the form of Emeraldine Base and organomodified clay as corrosion preventing agents and to methods for the preparation thereof.

### DESCRIPTION OF RELATED ART

Corrosion of metal surfaces, such as steel, is a significant problem and in the prior art several ways have been suggested for solving this problem. The simplest procedure is to passively coat the metal surface with a coating, comprising different resins. It provides surface protection if the coating is defect-free and does not allow diffusion of corrosives such as water, oxygen, electrolytes and the like through it. In this regard, one of the most common techniques is to add corrosion resistant agents to coating formulations to provide active surface protection.

It is well known that the barrier properties of a resin as main component of coatings can be improved by the addition of impermeable plate like structures. Coatings containing barrier pigments prevent, reduce, or inhibit the permeation of corrosives have been widely described, and such coatings have been commercialized for use in different industries. In such coating materials, when the layered plates are oriented perpendicular to the diffusion (or permeation) direction, the corrosive agents must go around the plates. This leads to significant reductions in the permeability of such coating. See, for example, W. J. Ward et al, J. Membrane Sci., 55:173 (1991); Chang, J. et al, Journal of Applied Polymer Science, Vol. 84, 2294 (2002); Yano, K. et al, Journal of Polymer Science A: Polymer Chemistry, 35, 2289 (1997); Lan, T. et al, Chem. Mater. 6, 573 (1994); Messersmith, P. B. and Giannelis, E. P, Journal of polymer Science A: Polymer Chemistry 33, 1047 (1995); U.S. Pat. Nos. 4,528,235; 4,960,639; 4,983,432; and 5,049,609; among others R. K. Bharadwaj, “Modeling the Barrier Properties of Polymer-Layered Silicate Nanocomposites”, Macromolecules 34, 9189 (2001); G. H. Fredrickson & J. Bicerano, “Barrier properties of oriented disk composites”, Journal of Chemical Physics 110, 2181 (1999).

However, use of platelet fillers in coating formulations is also well known. Most often, they have been used in paints to modify the rheology, enabling the production of no-drip paints.

Exfoliated silicates have been used to produce nanocomposite coatings by several methods. The most widely used has been by combining a dissolved polymer with exfoliated filler. Other polymers have also been made into barrier coatings by dissolving them in a solvent, and using organically functionalized filler in an effort to improve the barrier properties. See, for example, Yano, K., et al, “Synthesis and properties of polyimide-filler hybrid composites”, Journal of Polymer Science A: Polymer Chemistry, 35, 2289 (1997).

A method used to form nanocomposites by incorporating the exfoliated filler into the monomer before polymerization is found in U.S. Pat. No. 4,889,885 “Composite Material Containing a Layered Silicate”, Dec. 26, 1989. These methods were designed to help make bulk nanocomposites for thermal processing; none of the methods led to practical coating formulations.

Feeney et al, U.S. Pat. No. 6,087,016, “Barrier Coating of an Elastomer and a Dispersed Layered Filler in a Liquid Carrier”, Jul. 11, 2000; Feeney et al, U.S. Pat. No. 6,232,389, “Barrier Coating of an Elastomer and a Dispersed Layered Filler in a Liquid Carrier and Coated Articles”, May 15, 2001; Goldberg et al, “Nanocomposite Barrier Coatings for Elastomeric Applications”, Materials Research Society, Symposium T: Polymer nanocomposites, paper T.sup.4.7, (April 2002); These references do not employ ion exchange techniques to make the filler surface more compatible with the polymer because it typically causes the filler to fall out of aqueous suspension.

The approach used by us and described in this patent differs from the above arts in that it leads to stable coating formulations that can be applied to steel substrates in order to form an epoxy-clay nanocomposite coating.

In addition of barrier properties, passivity of the surface by the coating materials is one of the most important factors which affect the corrosion resistance ability of coatings. Pigments are commonly added to the coating formulations to increase the surface protection and passivation of ferrous and nonferrous substrates. Description of the role of different pigments and extenders in corrosion resistance properties of coatings can be found in “Coatings and surface coating”, by R. Lambourne and T. A. Strivens, Woodhead Publishing, Ltd, 1999, pp. 162-165.

On the other hand, there has been a push towards reducing or eliminating heavy metal pigments like hexavalent chromium compounds for safety and environmental reasons, and therefore new concepts for replacing these materials are called such as EPA Federal Register, “National Emission Standards for Hazardous Air Pollutants for Source Categories: Aerospace Manufacturing and Rework Facilities”, 60, 45947 (1995). The use of conjugated polymers as additives of coatings to provide anticorrosion effects has been extensively reviewed in the art (W. K. Lu, S. Basak, and R. L. Elsenbaumer, in Handbook of Conducting Polymers, Marcel Dekker, Inc. 1998, p. 881. It has been suggested to use pyrroles derivatives as corrosion inhibiting additives (R. M. Hudson and C. J. Warning, Metal Finish. 64 (1966), P 63). It can be concluded that conjugated polymers and also layered silicates are shown in the prior art to have corrosion inhibiting properties.

Conjugated polymers can in principle be used to overcome to the corrosion of metals. MacDiarmid suggested use of conducting conjugated polymers to allow anodic protection of steel and other metals (Lecture Series at State University of New York, 1985). D. W. DeBerry (J. Electrochem. Soc. 132 (1985) 1022) found that polyaniline electrochemically deposited on stainless steel provides anodic protection. Since then, there has been considerable effort to develop methods based on conjugated polymers, such as substituted polythiophenes, polypyrroles and polyanilines. Polyanilne because of its low cost and availability has been attended. However, that is a major and extensively reported complication due to the rigidity of the conjugated polymers for using these types of materials. Conjugated polymers, in general, do not melt or dissolve in usual polymers or solvents because of their low conformational entropy (J. I. Kroschwitz, High Performance Polymers and Composites, Wiley, 1991).

For using conjugated polymers, a commonly used method to identify solvents is based on matching solubility parameters (D. W. Van Krevelen, Properties of polymers, Elsevier, N.Y., 1990, p. 875). In spite of this well documented inconsistency, there have been efforts to use solubility parameters to identify solvents for polyaniline, as disclosed in U.S. Pat. No. 5,278,213.

Due to the poor solubility of the conjugated polymers, finding suitable processing routes to produce coating formulations, in particular anticorrosion coatings, becomes particularly challenging, and preparation of coatings and identifying suitable solvents are intimately connected. The present application deals with Emeraldine Base as a nonconductive form of polyaniline (EB-PANI). Several solvents for EB-PANI have been experimentally identified and disclosed. U.S. Pat. No. 4,913,867 describes N-methyl pyrrolidone (NMP) as a solvent for EB-PANI. Closer studies reveal that such solutions are unstable against gelation upon prolonged storage (K. T. Tzou and R. V. Gregory, Synthetic Metals 69 (1995), pp. 109). Other solvents have also been reported, such as dimethyl sulfoxide, dimethyl formamide, and N, N′-dimethyl-propylene urea. U.S. Pat. No. 5,278,213 describes a wide variety of solvents and claims solvents with sufficiently high polarity with solubility parameter from ca.Sup.17 MPa to ca. sup.29 MPa. In addition to the problems to classify solvents of rigid polymers by solubility parameters, said patent specification describes solely the use of polyaniline/solvent solutions where all or portion of said solvent is removed from said solution in the end to form solidified neutral polyaniline coatings. However, it should be noted that U.S. Pat. No. 5,278,213 does not present or anticipate a case where the solvents would be a portion of solid film which crosslinked instead of its removal.

EP Patent Specification No. 0 581 886 B1 and EP Patent Specification No. 0 623 159 B1 discloses a concept where a neutral polyaniline forms a fine dispersion with particle size less than 100 nm within a liquid medium where the latter is removed in the end, and where said article is doped for conductivity, unlike in the present invention which deals concepts for EB-PANI dispersed into the coating components without any remove of other materials.

U.S. Pat. No. 5,441,772 describes the use of neutral polyaniline solutions to provide coatings which, upon removal of the solvent, render corrosion protection of steel. U.S. Pat. No. 5,441,772 discloses that the composition can include other polymers that are miscible with polyaniline. As neutral polyaniline is immiscible with epoxy resin, the concept is different from the present invention. U.S. Pat. No. 5,658,649 discloses a method to provide two-layer structure where a doped conducting polyaniline is mixed with epoxy resin and cured. Subsequently a second layer, i.e. a topcoat, is added to provide increased mechanical integrity. Unlike our work, U.S. Pat. No. 5,658,649 deals with the conducting form of polyaniline. U.S. Pat. No. 5,645,890 again describes solutions of neutral undoped polyaniline films cast from solvents, such as N-methyl pyrrolidone or dimethyl sulphoxide, upon removal of the solvent. U.S. Pat. No. 5,648,416 describes a wide variety of coating formulations where the neutral undoped polyaniline is dispersed within said coating formulations consisting of one or more binders dispersed within a liquid medium.

EB-PANI is one of the feasible candidates to inhibit corrosion propagation under nearly neutral conditions. Taking also into account its economics and low cost, a wide variety of concepts based on polyaniline has been discussed in the prior art either based on solution casting where a solvent is totally or partly removed at the end to allow solid neutral coating or dispersion where the neutral polyaniline has been dispersed in a wide variety of coating formulations. Unlike our work, the first case deals with evaporation of large amounts of volatile potentially harmful organic solvents and the latter case requires relatively large amount of dispersed polyaniline particles to allow anticorrosion effect. An interesting approach to the manufacture of coatings from non-conducting polyaniline and epoxy resins is discussed by X.-H. Wang et al. In “Polyaniline as marine antifouling and corrosion-prevention agent”, Synthetic Metals 102 (1999) 1377. According to Wang, a solvent free corrosion prevention coating based on epoxy and EB-PANI could be produced by dissolving Emeraldine Base in tetraethylene pentaamine, which is mentioned as a curing agent of epoxy resin but it must be noted that the dispersion of EB-PANI in tetraethylene pentaamine is not stable and has a poor corrosion resistant properties (U.S. Pat. No. 6,500,544).

A very interesting approach to the manufacture of coatings from EB-PANI and epoxy resins is discussed by tiitu et al (U.S. Pat. No. 6,500,544 and also in “Aminic epoxy resin hardeners as reactive solvents for conjugated polymers: polyaniline base/epoxy composites for anticorrosion coatings”, Polymer 46 (2005) 6855. According to Tiitu et al., a corrosion prevention coating based on epoxy and EB-PANI could be made with different amines suggested and have showed. However, according to our experiments, the dissolution of EB-PANI in TMDA, practically, is very poor, comparing with IPDA. Also, the base component of their used system was based on neat epoxy resin while the base component of our system based on epoxy-clay nanocomposite. Also as depicted in their figures, there are many aggregates and phase separation of EB-PANI has been observable, while in our system the full dispersion of clay particles and EB-PANI has been occurred and in hardening component the average particle size is less than 400 nm. On the other hand based on Wessling, the dissolution of EB-PANI in the organic materials really impossible and with correct selection of solvent system for EB-PANI, different types of morphology like primarily particles and primary aggregates and secondary particles can be achieved (Bernhard Wessling, chemical innovation, ACS, January 2001, vol 31, no 1, pp 34-40). Our processing and manufacturing technique leads to the dispersion of primary particles and also primary and secondary aggregates of EB-PANI into the resultant coating material which containing layered silicates.

### SUMMARY OF THE INVENTION

It is an object of the present invention to manufacture and provide a two-component nanocomposite coating composition, comprising a base component comprising curable binder plus layered silicates and also curing component comprising of Emeraldine Base form of polyaniline dissolved in special amines.

It is another object of the invention to provide a method of preparing and processing of each component of coating composition. The third object of this invention is to provide a method of application such nanocomposite coating composition on the steel surfaces. The fourth object of this invention is to provide coated metal substrates with improved corrosion resitivity.

Yet, it is another object of the present invention to manufacture and provide a two component nanocomposite coating composition, consisting of:

a) a base component containing at least one curable resin and at least one type of layered silicate filler material which organically treated with amine derivatives;
b) a curing agent or hardener component containing Emeraldine Base form of polyaniline dispersed in at least one organic amine, which have a solubility parameter for said polyaniline of at least 17 MPa.sup.1/2.

Yet, it is another object of the present invention to manufacture and provide a two-component nanocomposite coating composition, wherein said at least one organic amine of curing agent component comprises a branched-chain cycloaliphatic amine compound with at least two primary amine groups.

Yet, it is another object of the present invention to manufacture and provide a two-component nanocomposite coating composition, wherein said nanocomposite coating composition comprises between about 1 wt. percent and about 8 wt. percent layered silicate filler material.

Yet, it is another object of the present invention to manufacture and provide a two-component nanocomposite coating composition, wherein said silicate filler material is organomodifiled montmorillonite.

Yet, it is another object of the present invention to manufacture and provide a two-component nanocomposite coating composition, wherein said composition prior to application on substrates has a total solids content of from about 90 to about 100%.

Yet, it is another object of the present invention to manufacture and provide a two-component nanocomposite coating composition, wherein the organic cycloaliphatic amine used in the curing agent having 3 to 10 carbon atoms.

Yet, it is another object of the present invention to manufacture and provide a two-component nanocomposite coating composition, wherein the cycloaliphatic amine used in curing agent is isophoronediamine.

Yet, it is another object of the present invention to manufacture and provide a two-component nanocomposite coating composition, wherein said organic amines used in curing agent component comprises of at least one polyamidoamine derivatives.

Yet, it is another object of the present invention to manufacture and provide a two-component nanocomposite coating composition, wherein the curing agent component contains 0.05 to 2.5% by weight of Emeraldine-Base form of polyaniline wherein said Emeraldine-Base form of polyaniline is dispersed in the liquid-phase of curing agent.

Yet, it is another object of the present invention to manufacture and provide a two-component nanocomposite coating composition, wherein the Emeraldine-Base form of polyaniline comprises undoped polyaniline having a conductivity of less than 10.sup.-8S/cm.

Yet, it is another object of the present invention to manufacture and provide a two-component nanocomposite coating composition, wherein the curing agent component contains the dispersed Emeraldine-Base form of polyaniline with the particle size less than 450 nm.

Yet, it is another object of the present invention to manufacture and provide a two-component nanocomposite coating composition, wherein said at least one curable resin in base component is selected from a group consisting of epoxy resins wherein said epoxy resins consist of condensates of bisphenol and having diglycidylether groups.

Yet, it is another object of the present invention to manufacture and provide a two-component nanocomposite coating composition, wherein the curing agent component is substantially free from aggregates of Emeraldine Base polyaniline.

Another object of the present invention is to provide a method of preparing and applying a coating composition wherein said method comprises the steps of:

providing a base component containing a binder as matrix and organomodified layered silicate;
Preparing a curing agent or hardening component containing of at least one organic amine compound, wherein said curing agent or hardening component comprises of at least two primary amine functions, and wherein said preparing consists of dissolving 0.01 to 2.5 weight-% of Emeraldine-Base polyaniline, wherein said dissolving weight is based on the weight of the hardening component.

Another object of the present invention is to provide a method of preparing and applying a coating composition wherein said binder comprises a curable epoxy resin and wherein said curable epoxy resin consists of condensate of bisphenol and having glycidylether groups.

Another object of the present invention is to provide a method of preparing and applying a coating composition wherein said method further comprises step of: mixing a predetermined amount of solvents and a predetermined amount of additives with said base component and said curing agent component, wherein said base component and said curing agent component are placed into two separate containers.

Another object of the present invention is to provide a method of preparing and applying a coating composition wherein said method further comprises steps of:

mixing the base component with the curing agent component to provide a curing mixture;
and applying the mixture on a steel substrate to avoid corrosion of said steel substrate, wherein said steel substrates are mild or carbon.

These and other objects, together with the advantages thereof over known methods and products, which shall become apparent from the specification, which follows, are accomplished by the invention as hereinafter described and claimed.

The present invention is based on the finding that EB-PANI can be dispersed in a specific group of curing agents comprising an organic amine having primary amine groups to form stable dispersion. Also for increasing the barrier effect of such coating composition the layered silicates in the form of MMT is introduced, dispersed and the clay layers, at least partially exfoliated in the base component of coating composition. According to a preferred embodiment, EB-PANi is dispersed in one or more basic hardeners of epoxy resins that form stable dispersion optionally containing also other additives and the mixture is thereafter cross-linked with base component to form solid surface coating. The method of forming a coating on the surface of an object typically includes the steps of:

a) Dispersion of EB-PANi in a hardener of epoxy, optionally containing also other amines and additives via ultrasonication.
b) Preparation of hardening component by removing the undisolved or undispersed particles via centrifuging and filtration to reducing the EB-PANi particle size to less than 450 nm for reaching to even to primary aggregates.
c) Preparation of nanocomposite base component via introduction of organomodified layered silicates into the epoxy resin via high shear mixing plus ultrasonication.
d) Mixing the base component and hardener component.
e) Optionally adding further additives to the mixture.
f) Applying the mixture on the pretreated steel surfaces
g) curing the nanocomposite coating.

Considerable advantages are obtained due to our processing and dispersion techniques. Thus, the present invention represents a straightforward and economically attractive procedure for producing coatings materials comprising of EB-PANI and MMT. Each component of coating produced by the invention is stable over extended periods of time, which facilitates storage, and transportation of the coating compositions. The anti-corrosive effect of the coating compositions is very good. Surprisingly it has been observed that required amount of EB-PANi and layered silicate is low, typically about 0.5% and 3% by weight, respectively to allow for a substantial anticorrosion effect.

### BRIEF DESCRIPTION OF THE DRAWINGS

FIG. 1. Optical micrograph of a sample containing 3% by weight MMT in epoxy resin via a) high shear mixing b) high shear mixing plus sonication, showing that MMT is not fully dispersed via high shear mixing but the well dispersion can be seen in the ultrasonicated mixture.

FIG. 2. Optical micrograph of a sample initially introducing of 0.5% by weight EB-PANi into the isophoronediamine (IPDA) via a) high shear mixing plus sonication, b) high shear mixing, sonication and centrifuging, c) high shear mixing, sonication, centrifuging, and filtrating. As showing in this figure, the amount of undissolved and undispersed EB-PANi is reduced in each step and the final mixture is integral and homogenous compound.

FIG. 3. Propagation of corrosion in the scribed surface after 500 hr salt fog of steel coated and cured of a) neat epoxy resin, B) fully cured nanocomposite coating containing 0.5 WT % of EB-PANi and 3 wt % of MMT. The EB-PANi was high-shear mixed, sonicated, centrifuged, and filtrated has been mixed and dispersed IPDA as curing agent component. THE MMT was high shear mixed and ultrasonicated in base component. The base component and hardening component was then mixed and applied on pretreated steel and cured.

FIG. 4. Optical micrograph of a sample containing 0.5% by weight EB-PANi mixed with TMDA, showing that EB-PANi is not generally soluble in the basic hardeners of epoxy resin at dilute concentrations.

FIG. 5. Typical example of EB-PANi/IPDA-MMT/epoxy coating on steel plate. Sample has been prepared using our method and applied on the substrate with 30mu.m. The sample has been exposed to 3.5% NaCl solution for 350 days. After the exposure the fig shows that there is not any sign of the progress of the corrosion or blistering in the surface of coating.

### DETAILED DESCRIPTION OF THE INVENTION

The term “nanocomposite” or “filled polymer nanocomposite” refers to the mixture of substantially exfoliated or partially exfoliated with the thickness of at least some filler particles is below 1 micron, and probably well below 100 nm.

Exfoliation is defined for layered fillers as the separation of individual layers of the original particle. The layered silicate fillers are exfoliated so that the polymer may surround each particle. Desirably, a sufficient amount of polymer is present between each platelet, that the platelets are randomly spaced. Preferably, no X-ray line appears because of the substantially random spacing of exfoliated platelets and increasing the d-spacing between clay layers more than 10 nm. In some circumstances, the filler can exfoliate when dispersed in an aqueous or non-aqueous medium. This would result in a higher aspect ratio than that of a solid particle before dispersion.

A coating includes a liquid containing suspended solid, which is used to apply the solids to a substrate. This includes a colloidal dispersion, suspension, emulsion and latex as they are conventionally defined. A novel aspect of the present invention is that the base component of nanocomposite coating mixtures provide a better dispersion of layered silicates in epoxy at an unusually low solids content, e.g., between more than about 95%. According to this invention, once the base component and hardening component is mixed together and applied on steel substrates and cured, it is sometimes referred to as a “dried coating” or a “film”.

When the term “EB-PANI” is used in this application, it is used generally to include not doped, by electron or proton, form of unsubstituted polyaniline. The conductivity of this material is very low, less than about 10.sup.-8 S/cm.

PANI is well known in the art, and its synthesis and the preparation of the electrically non-conductive forms thereof have been described in great detail in the literature. Illustrative of some useful forms are those described in U.S. Pat. Nos. 5,232,631 and 4,983,322, incorporated by reference herein. Useful polyanilines can be prepared by any chemical and electrochemical synthetic procedures referred to, for example, in the above publications incorporated herein by reference.

As a hardening component of the present coating compositions there may be used IPDA plus EB-PANI described in U.S. Pat. Nos. 5,069,820, 5,160,457 and 5,232,631.

When the term “epoxy resin” as the matrix for base component is used, it is employed for designating molecules containing diglycidylether groups. Preferred epoxy resins are prepared from epichlorohydrin and a dihydroxyl compound, usually a bisphenol A or bisphenol F. The polymer has epoxide rings at each end and hydroxyl groups along the chain, which ensure good adhesion to polar surfaces such as metals. Epoxy resins must be converted to suitable cross-linked products by reaction with curing agent or hardening agent, e.g., amines, polyamide resins, polysulfide resins, anhydrides, metallic hydroxides, or Lewis acids.

The term “hardener” or curing agent comprises any chemical compound that is capable of forming a cross-linked network structure when mixed at specific weight ratio with the base component, at suitable curing temperature.

Most of the epoxy coating materials is supplied as two-package systems to be mixed just before application on substrates. Polymer curing takes place by reaction of a curing agent with epoxide rings to cross-link the polymer and construction of network. Coatings made from epoxy resins have excellent chemical resistance and hardness and are often used for corrosion protection, maintenance coatings, trade sales specialties, and industrial finishes. Chalking with exterior exposure and these coating systems is their main limit for their usage as topcoat.

According to the present invention the curing agent comprises a compound having at least two terminal functional amine groups. The functional groups of the curing agent are capable of reacting with functional groups of the matrix resin in base component and therefore one molecule of the curing agent is capable of binding together at least two matrix resin binder molecules to achieve cross-linking of the matrix. Preferably the curing agent is a basic amine which comprises primary amine groups which are capable of reacting with functional groups of the matrix resin of base component.

Preferably the curing agent comprise at least one branched-chain cycloaliphatic amine compounds with at least two primary amine groups and having a solubility parameter for EB-PANI of at least 17 MPa.sup.1/2, and which is capable of dispersion of at least 0.1%-wt EB-PANI to be essentially particle-free in visual inspection. At least one of the amines used as hardening component is isophoronediamine (IPDA).

The hardening component comprises 0.01 to 5%, preferably 0.1 to 2.5%, of EB-PANI having a conductivity of less than 10.sup.-6 S/cm, preferably less than 10.sup.-8 S/cm. The present hardening component is typically a liquid curing agent capable of curing the base component containing epoxy resin and layered silicates and capable of dispersing EB-PANI.

The capability of any aminic curing agent of dissolving EB-PANI is judged using visual inspection and optical microscopy and scanning electron microscopy. Therefore, a mixture of curing agent component containing cycloaliphatic amine and EB-PANI which does not exhibit any or only minute amounts of insoluble particles is considered to comprise EB-PANI dissolved or dispersed in the curing agent. The below examples will illustrate this feature in detail with reference to the attached figures.

According to a preferred embodiment, the method according to the invention comprises basically the steps of providing a base component containing a binder and a layered silicate, also providing a hardening component containing at least a cycloaliphatic amine as a liquid cross-linking agent for the binder and EB-PANI.

Dissolving 0.1 to 2.5-wt % of EB-PANI. in the liquid-phase of curing agent, said amount of the EB-PANI being calculated from the weight of the curing agent.

The base component binder is arranged into a first container optionally together with defoamer and leveling agent additives. The curing agent component containing the dispersed EB-PANI, optionally is arranged into a second container.

The method of application such coating composition on the surface of pretreated steel substrates, comprises the steps of providing a base component containing epoxy resin and layered silicate, also providing a hardening component containing a liquid phase cycloaliphatic amine beside EB-PANI as curing agent capable of curing the base component. Mixing the base component with the hardening component to provide a uniform mixture, applying the mixture on the surface of substrate, and allowing the mixture to cure so as to form a coating on the surface.

According to the invention, the hardening component comprises an organic cycloaliphatic amine of the above-discussed kind. In the curing agent of the hardening component there is dispersed, before mixing it with the resin component, a non-conducting polyaniline polymer (EB-PANI) in an amount sufficient to provide a cured coating composition on the surface of the object containing a maximum of 0.5% EB-PANI.

The coating is formed on steel surfaces prone to corrosion when subjected to corrosive conditions. The surface comprises a mild steel or carbon steel.

Since dissolved or dispersed EB-PANI are most often colored, they resultant coating may provide a blue color function.

In addition to the layered silicate, binder, and EB-PANI and aminic resin, such coating also may contain some optional additives, such as defoamers, thickeners, flow agents, and plasticizers to improve various properties of the resultant coating. The selection of the binder and additives depends, of course, upon the properties desired in the coating to be made.

According to a preferred embodiment, EB-PANI is dispersed in Isophoronediamine (IPDA), which is in this art known to be a hardener of an epoxy binder. This leads to essentially particle-free solution as judged based on visual inspection and optical microscopy and scanning electron microscopy (SEM). Such solution is subsequently used as cross-linking agent by adding to the composition containing epoxy resin and layered silicates to allow solid deep blue coating of steel surfaces. Additional additives are anticipated with such formulations, such as additional resins or hardeners, as well as additional other anticorrosion pigments in which case synergistic effects are requested. That the preparation technique in the relevant invention is demonstrated henceforth in the examples to be discussed in some detail.

The coatings according to the present invention can be used for the same purposes as conventional coatings, e.g. as primer coats, undercoats.

The present invention provides a method of preventing or reducing (retarding) corrosion of steel with using corrosion inhibiting materials i.e. small amounts of clay and nonconductive conjugated polymers.

The surface of the substrate metal is first pre-treated before the coating composition is applied thereon. The pre-treatment step typically comprises the step of removing dirt, dust and fat and other impurities by solvent cleaning. If necessary, the surface may also be subjected to abrasive agents such as sand or cooper slag blasting, to remove any surface layer of oxidated metal on the surface of substrate.

The nanocomposite coating composition may be applied on the surface of substrates in particular by spraying using air or airless spray equipment or brushing.

The following general methods and specific examples are presented merely to illustrate the invention and are not to be construed as limitations thereon.

Method a: The as supplied EB-PANI was dried in a vacuum oven at room temperature for 48 hours. The molecular weight was M.sub.n=55,000 g/mol.
Method b: measurement of the coating resistance via electrochemical scanning spectroscopy:
The coating comprising of the resin(s), the hardener(s), EB-PANI and layered silicates and other additives (as proper for the quality and the type of the coating), was applied on a test steel plates with specifically cleaned surface, with surface roughness (Rz) of 3 micron, using an film applicator that allows a layer of uniform thickness of 30. mu.m. The coating is cured at 1 h at 90.degree. C. For the EIS measurements, a three-electrode cell is used: the working electrode with an exposed area of 1 cm2 of coated steel plates, an Ag/AgCl and a platinum auxiliary electrode. The corrosive medium is a 3.5 wt % of NaCl solution at ambient temperature. Other areas of working electrodes were sealed with 2.5:1 mixture of beeswax-colophony. The electrochemical impedance measurements are performed using a suitable system like an Autolab G12. The measurements are carried out during 350 days of immersion at open circuit potential at frequency range of 10⁻²-10⁺⁴ Hz with 10 mV perturbations. EIS data are analyzed by appropriate software. Three samples are tested to ensure reproducibility. The blistering and rusting or other defects are carefully inspected and subsequently the resistance of the film of coating is carefully measured in different times of immersion. The experiment is repeated for different coating compositions containing different amount of layered silicate and different concentrations of EB-PANI in the coating composition, and different immersion times.

The results of impedance measurement of different coatings on steel substrates, as the results of Bode diagrams, after 10, 30, 90, 150, 210, 340 days of immersion in 3.5% NaCl solution are shown in Table 1. According to the literature, the impedance modulus at 0.01 Hz (|Z|_{0.01Hz}) is an appropriate parameter for characterization of the protective properties of the coatings. Good correlation between the low frequency (LF) impedance value and protective performance of coating has been reported, and it is considered that a coating with good anticorrosion performance should show LF impedance above 10E8 Ω·cm², whereas a poor or failed coating shows a LF impedance less than 10E5 Ω·cm2. Salt fog test was performed according to ASTM B 117. The coated plates were exposed to a salt spray chamber in which a solution of 5 wt % NaCl was sprayed according to ASTM B 117 (atomization and quantity of fog) at a temperature of 37° C. The evaluation of scribed and nonscribed zones of test plates was formed by visual inspection.

### Example 1

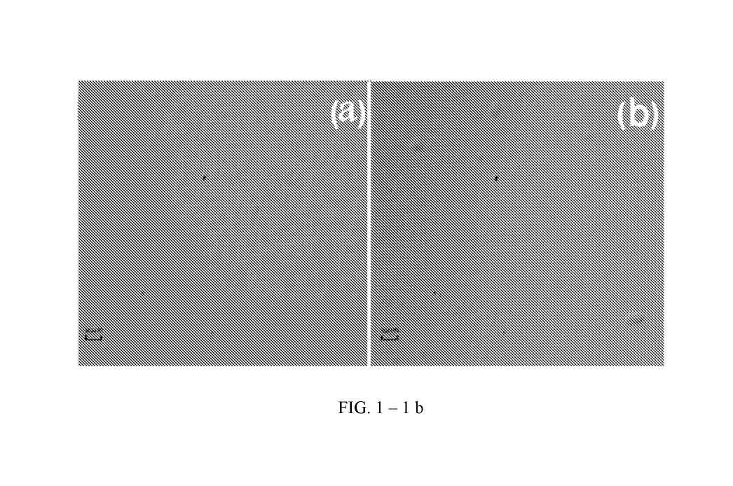

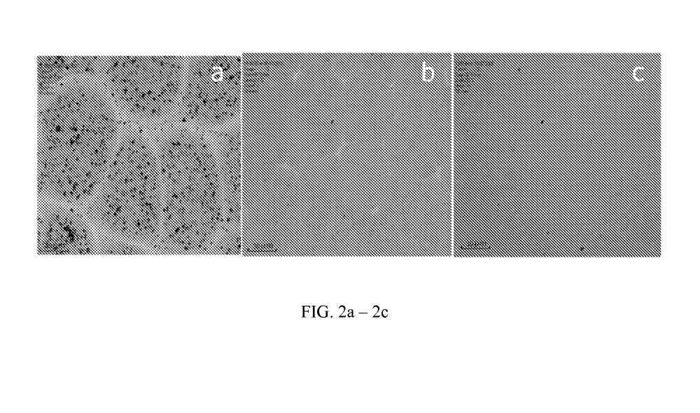

The base component is prepared with introducing of 3.4 gr of organomodified MMt clay gradually was poured into 100 gr EPON 828 as a liquid epoxy resins based on diglycidylether of bisphenol A. The epoxy equivalent weight of resin is between 175-190 gr. The mixing process is preformed under high-shear mixing with 2500 rev/min for 1.5 hr. After that the mixture was ultrasonicated for 2.5 hr. It is observed, that MMT was dispersed in said epoxy resin as there are dispersed particles observed in optical microscopy. As shown in FIG. 1 and FIG. 2.

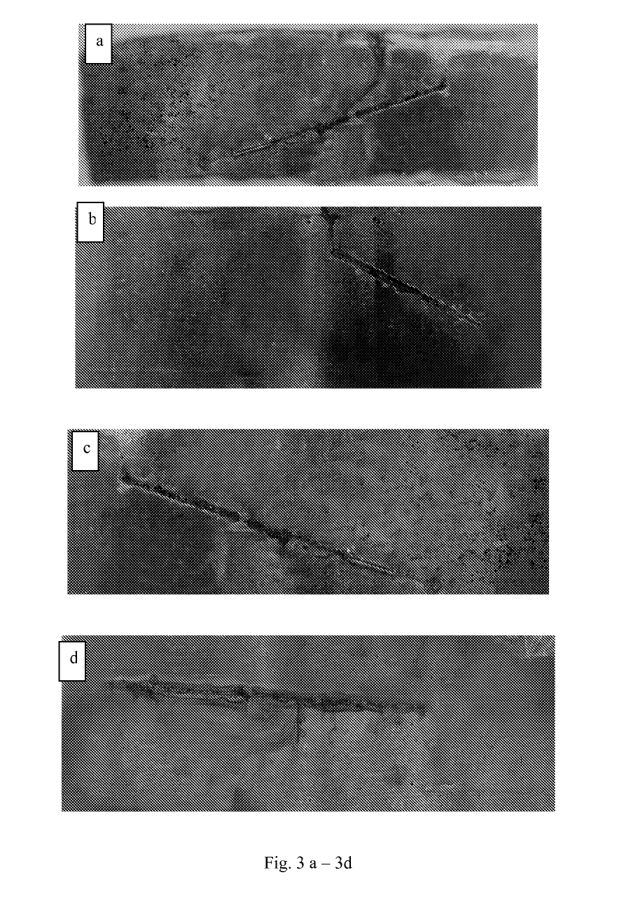

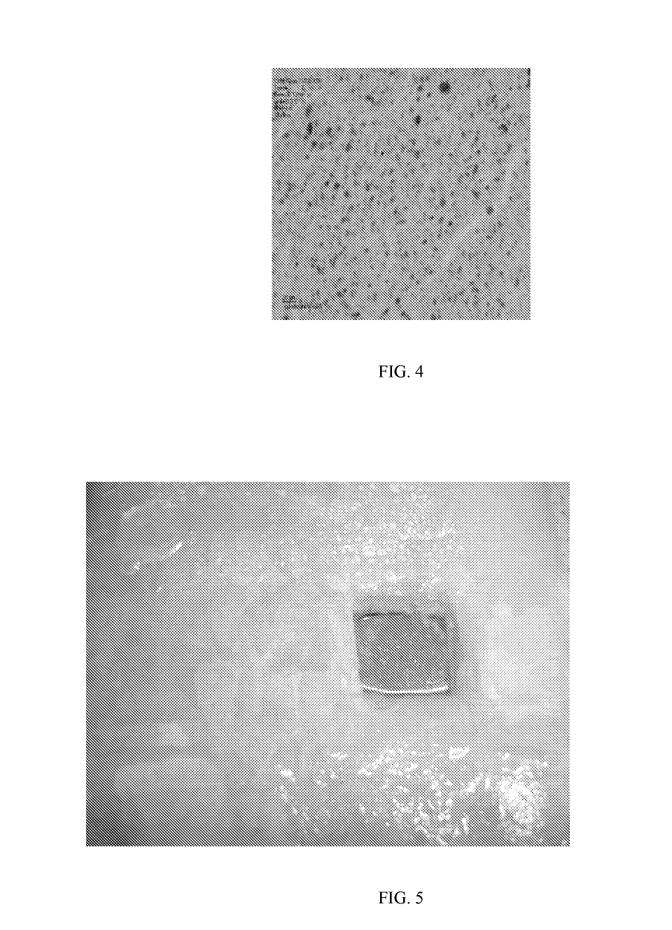

On the other hand the hardening component is prepared with gradual pouring 0.6 gr of EB-PANI into the 22 gr of IPDA using a magnetic stirrer and 2.5 hr sonication at 50.degree.C. in an Erlenmeyer flask. The temperature was remained constant during sonication process using the water bath. At that time, the mixture turned out to be homogeneously blue. After mixing and ultrasonication, the mixture was centrifuged for 45 min and then filtrated via 450 nm PTFE filter so insoluble polyaniline aggregates is removed. Optical microscopy of hardening composition revealed hardly any insoluble particles, as shown in FIG. 2. It can be concluded that EB-PANI disperse to primary aggregates and secondary particle sizes at dilute concentrations, such as 0.5% by weight, in a basic hardener of epoxy resin, i.e. IPDA 100 gr of said base component mixed with 22 gr of hardening component. The resulting mixture is applied onto a solvent cleaned steel plate and cured at 90.degree. C. for 1 h. A cross-linked film of epoxy nanocomposite coating containing 3 wt % of MMT and 0.5 wt % by weight of EB-PANI in the final composition is thus formed. The anticorrosion properties of said coating were studied using Method B. The resistance of such coating is shown in table 1. As depicted in FIG. 3(b), after 500 hr salt fog test based on ASTM B117, there is not sign of rust or blister on the scribed and unscribed surface such coating.

### Example 2

Example 1 was repeated without layered silicate to render a coating composition without MMT. 22 gr of hardening component which prepared as example 1 was mixed with 100 gr of EPON 828. The mixture was applied on steel substrate as example 1. The resistance of such coating is shown in table 1.

### Example 3

Example 1 was repeated without polyaniline to render a coating composition without EB-PANI. 100 gr of base component which prepared as example 1 was mixed with 22 gr of IPDA. The Mixture was applied on steel substrate as example 1. The resistance of such coating is shown in table. After 500 hr salt spray test based on ASTM B117, there is not sign of rust or blister on the unscribed surface such coating but the progress of corrosion in the scribed surface of such coating.

### Example 4

Example 1 was repeated without EB-PANI and layered silicate to render a coating composition without EB-PANI and MMT.100 gr of EPON 828 was mixed with 22 gr of IPDA. The Mixture was applied on steel substrate as example 1. The resistance of such coating is shown in table [1]. After 500 hr salt spray test based on ASTM B117, there is not sign of rust or blister on the unscribed surface such coating but the progress of corrosion in the scribed surface of such coating as shown in FIG. 3(a).

### Example 5

Example 3 was repeated with lower amount of layered Silicate to render a coating composition with small amount of MMT. 100 gr of base component, which prepared as example 1 except that the layered silicate wt % was 1%, was mixed with 22 gr of IPDA. The Mixture was applied on steel substrate as example 1. The coating resistance of such coating is shown in table. After 500 hr salt spray test based on ASTM B117, there is not sign of rust or blister on the unscribed surface such coating but the progress of corrosion in the scribed surface of such coating as depicted in FIG. 3(c).

### Example 6

Example 2 was repeated with lower amount of polyaniline to render a coating composition with small amount of EB-PANI. 100 gr of base component which prepared as example 1 was mixed with 22 gr of hardening component which containing 0.2 gr. IPDA. The Mixture was applied on steel substrate as example 1. The coating resistance of such coating is shown in table [1]. After 500 hr salt spray test based on ASTM B117, there is not sign of rust or blister on the unscribed surface such coating but the progress of corrosion in the scribed surface of such coating as shown in FIG. 3(d).

TABLE 1
COATING resistance of coatings in different immersion times

| | | | coating | coating | coating | coating | coating | coating |
|---|---|---|---|---|---|---|---|---|
| | | | resistance | resistance | resistance | resistance | resistance | resistance |
| | | wt % | after 10 | after 30 | after 90 | after 150 | after 210 | after 350 |
| | wt % | of | days | days | days | days | days | days |
| Example | of | EB- | (Ohm · cm · | (Ohm · cm · | (Ohm · cm · | (Ohm · cm · | (Ohm · cm · | (Ohm · cm · |
| No | MMT | PANI | sq · 2) | sq · 2) | sq · 2) | sq · 2) | sq · 2) | sq · 2) |
| 1 | 3 | 0.5 | 7.47E9 | 5.82E9 | 4.21E9 | 2.43E9 | 4.07E7 | 7.81E6 |
| 2 | 0 | 0.5 | 7.049E9 | 5.67E9 | 6.61E9 | 4.65E7 | 1.26E7 | * |
| 3 | 3 | 0 | 7.94E9 | 6.43E9 | 4.45E9 | 7.11E9 | 7.03E01 | * |
| 4 | 0 | 0 | 5.67E9 | 4.72E8 | 5.92E7 | * | * | * |
| 5 | 1 | 0 | 5.8E9 | 6.31E9 | 1.1E9 | 9.34E8 | * | * |
| 6 | 0 | 0.1 | 7.049E9 | 5.67E9 | 4.1E9 | 5.2E6 | * | * |

* has not value as protection of steel (less than 10 kOhm · cm · sq · 2)

Several conclusions can be made:

The examples showed that significant improvement of anticorrosion properties are obtained when a cycloaliphatic amine hardener of epoxy resin is identified which simultaneously acts as a dispersion media for EB-PANI, and also by addition of the MMT to the base component and construction of partially exfoliated nanocomposite. The basic invention of this work is the observation that layered silicates and EB-PANI materials can astonishingly have synergistic effects on corrosion resistance of resultant coatings. Having realized the principle, it is well anticipated that there are also other coating and coating formulations where, instead of just dispersing the conjugated polymer in the polymeric binder or addition of layered silicate materials to the coating compositions.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A two component nanocomposite coating composition, consisting of:
a) a base component containing at least one curable resin and at least one type of layered silicate filler material which organically treated with amine derivatives.
b) A curing agent or hardener component containing Emeraldine Base form of polyaniline dispersed in at least one organic amine, which has a solubility parameter for said polyaniline of at least 17 MPa.sup.1/2.

2. The coating composition according to claim 1, wherein said at least one organic amine of curing agent component comprises a branched-chain cycloaliphatic amine compound with at least two primary amine groups.

3. The coating composition according to claim 1, wherein said nanocomposite coating composition comprises between about 1 wt. percent and about 8 wt. percent layered silicate filler material.

4. The coating composition according to claim 1, wherein said silicate filler material is organomodifiled montmorillonite.

5. The coating composition according to claim 1, wherein said composition prior to application on substrates has a total solids content of from about 90 to about 100%.

6. The coating composition according to claim 1, wherein the organic cycloaliphatic amine used in the curing agent having 3 to 10 carbon atoms.

7. The coating composition according to claim 1, wherein the cycloaliphatic amine used in curing agent is isophoronediamine.

8. The coating composition according to claim 1, wherein said organic amines used in curing agent component comprises of at least one polyamidoamine derivatives.

9. The coating composition according to claim 1, wherein the curing agent component contains 0.05 to 2.5% by weight of Emeraldine-Base form of polyaniline wherein said Emeraldine-Base form of polyaniline is dispersed in the liquid-phase of curing agent.

10. The coating composition according claim 1, wherein the Emeraldine-Base form of polyaniline comprises undoped polyaniline having a conductivity of less than 10.sup.-8S/cm.

11. The coating composition according to claim 10, wherein the curing agent component contains the dispersed Emeraldine-Base form of polyaniline with the particle size less than 450 nm.

12. The coating composition according to claim 1, wherein said at least one curable resin in base component is selected from a group consisting of epoxy resins wherein said epoxy resins consist of condensates of bisphenol and having diglycidylether groups.

13. The coating composition according to claim 1, wherein the curing agent component is substantially free from aggregates of Emeraldine Base polyaniline.

14. A method of preparing and applying a coating composition wherein said method comprises the steps of:
providing a base component containing a binder as matrix and organomodified layered silicate;
Preparing a curing agent or hardening component containing of at least one organic amine compound, wherein said curing agent or hardening component comprises of at least two primary amine functions, and wherein said preparing consists of dissolving 0.01 to 2.5 weight-% of Emeraldine-Base polyaniline, wherein said dissolving weight is based on the weight of the hardening component.

15. The method according to claim 14, wherein said binder comprises a curable epoxy resin and wherein said curable epoxy resin consists of condensated of bisphenol and having glycidylether groups.

16. The method according to claim 14, wherein said method further comprises step of: mixing a predetermined amount of solvents and a predetermined amount of additives with said base component and said curing agent component, wherein said base component and said curing agent component are placed into two separate containers.

17. The method according to claim 14, wherein said method further comprises steps of:
mixing the base component with the curing agent component to provide a curing mixture; and
Applying the mixture on a steel substrate to avoid corrosion of said steel substrate, wherein said steel substrates are mild or carbon.
